(19) United States
(12) Patent Application Publication
(10) Pub. No.: US 2011/0115192 A1
(43) Pub. Date: May 19, 2011

(54) Bicycle Frame Having Webbed Tubing

(76) Inventors: James M. Helms, Fort Myers, FL (US); Mark R. Barie, Glenshaw, PA (US)

(21) Appl. No.: 12/622,328

(22) Filed: Nov. 19, 2009

(51) Int. Cl. B62K 3/04

(52) U.S. Cl. 280/281.1

(57) ABSTRACT

A frame for a bicycle where at least either the so-called top tube or the so-called down tube has a webbed interior space, i.e. has interior walls running along its length creating separately two or more enclosed subspaces spanning at least some of the length of the tube. Such a webbed frame is made, typically, by extruding a material such as aluminum or an alloy.

### TECHNICAL FIELD

The present invention pertains to the field of bicycles. More particularly, the present invention pertains to bicycle frames.

### BACKGROUND OF THE INVENTION

A bicycle frame is the main component of a bicycle and upon which all other components are fitted. The most common frame design for an upright bicycle is called a diamond frame, consisting of a pair of triangles, the main triangle and the rear triangle, and is the type of frame generally used for heavy duty bicycles, such as mountain bikes.

In a diamond frame, the main triangle consists of the head tube, top tube, down tube and seat tube. The rear triangle consists of the seat tube, paired chain stays, and paired seat stays. The top tube connects the head tube to the seat tube at the top of the frame, and the down tube connects the head tube to the lower end of the seat tube. Paired forks attach the front wheel to the head tube. The rear triangle consists of the seat tube and a pair of chain stays and a pair of seat stays. The paired chain stays run parallel to the chain, connecting the lower seat tube to the back wheel. The paired seat stays connect the upper end of the seat tube (often at or near the same point as the top tube) to the paired chain stays at the back wheel.

Although frame tubing generally has a hollow central core, cabling for the bicycle components are commonly routed along mounts on the top and down tubes. Most commonly, this includes the cable for the rear brake, but some mountain bikes also route the front and rear derailleur cables along the outside of the top tube. On racing bicycles and some mountain and hybrid bikes, the derailleur cables typically run along the down tube. While such arrangements are advantageous to the manufacturing process, there is a downside: attaching cabling to the tube exterior subjects the cabling to physical damage from the elements or from rough treatment of the bike.

A heavy duty bicycle frame has specific requirements and design challenges. The frame must be strong and durable, and yet as light as possible. It must be comfortable to ride, mount and dismount, and ideally be made of materials that make the bike affordable.

Generally, tubing used for diamond frames are made of steel, aluminum, titanium, metal alloys, or carbon fiber. Of these materials, metallic materials such as steel, aluminum and their alloys are most desirable for use in a heavy duty bicycle frame, as they are strong, affordable and easy to work with.

Comparing steel and its alloys such as chromium-molybdenum, or “chromoly” with aluminum and its alloys, the main drawback of steel (and its alloys) is that it is much heavier than aluminum (and its alloys), and methods used to decrease the weight, such as butting, in which the ends of the tubes are thicker than the central portions of the tubes, increases cost and manufacturing complexity. Aluminum and its alloys have an attractive strength-to-weight ratio compared to steel and its alloys, but an aluminum tube's optimal wall thickness-to-diameter ratio requires oversized tubing, in order to achieve acceptable yield strength, elongation limits, and durability. While the resulting frame tubing is significantly stiffer and lighter than steel, it is of a larger diameter, and is thus more bulky.

What is needed, then, is a heavy duty bicycle frame that is strong, durable, and affordable, and that can house, internally, cabling and other electrical components, and that has a profile that makes the frame easy to mount/dismount, and so is less bulky than a frame of simple aluminum tubing.

### DISCLOSURE OF INVENTION

The invention provides a bicycle frame including at least either a top tube or a down tube made from an extrusion having a webbed interior space. Such webbing provides both structural strength to the frame tubing and also provides internal compartments for housing mechanical and electrical cabling, protecting such cabling from physical damage as well as keeping the cabling organized and untangled.

### BRIEF DESCRIPTION OF THE DRAWINGS

The features and advantages of the invention will become apparent from a consideration of the subsequent detailed description presented in connection with accompanying drawings, in which:

FIG. 1 is a side perspective view of a prior art bicycle showing a standard diamond frame and components fitted to the frame.

FIG. 2 is a side perspective view of a bicycle frame according to the invention.

FIG. 3 is a cross-sectional view of a top or a down tube, showing the extruded interior partitions.

### DRAWINGS LIST OF REFERENCE NUMERALS

The following is a list of reference labels used in the drawings to label components of different embodiments of the invention, and the names of the indicated components.
10 bicycle frame
12 top tube
12p prior art top tube
12a hole
14 down tube
14p prior art down tube
14a hole
16 head tube
16p prior art head tube
18 seat tube
18p prior art seat tube
20 partition
22 back stay
22p prior art back stay
24 chain stay
24p prior art chain stay
100 prior art bicycle frame

### DETAILED DESCRIPTION

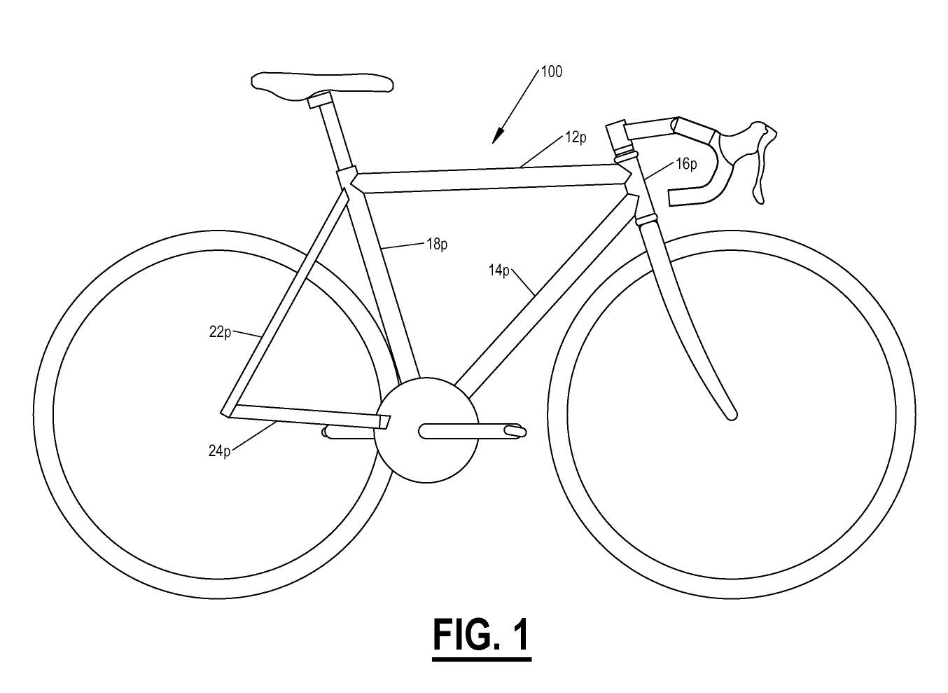

The invention provides a bicycle frame interchangeable with the prior art bicycle frame shown in FIG. 1. Briefly, the prior art bicycle frame 100 provides for a top tube 12p and a down tube 14p, each tube having two ends, one end of each tube fixedly attached to a head tube 16p and the other end of each tube fixedly attached to an upper and a lower end of seat tube 18p, respectively, forming a frame main triangle. The tubes 12p 14p are typically hollow. Paired back stays 22p and paired chain stays 24p, each stay having two ends, are affixed at one end to an upper and lower end of the seat tube 18p and to each other at the other end, thus forming a pair of rear triangles. The tubes are typically made of metals such as steel, or in some cases, non-steel materials such as carbon fiber.

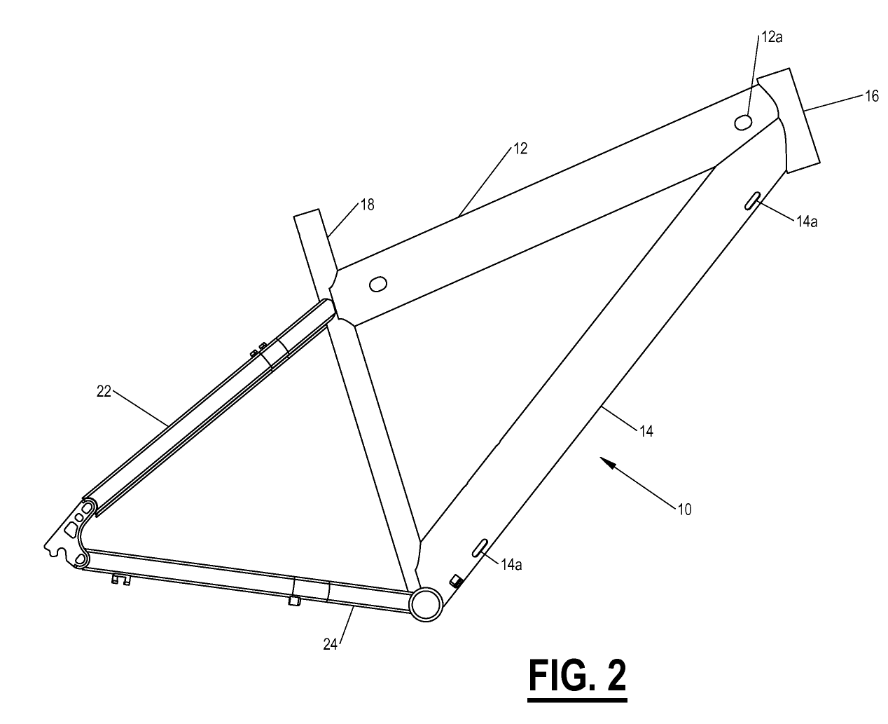

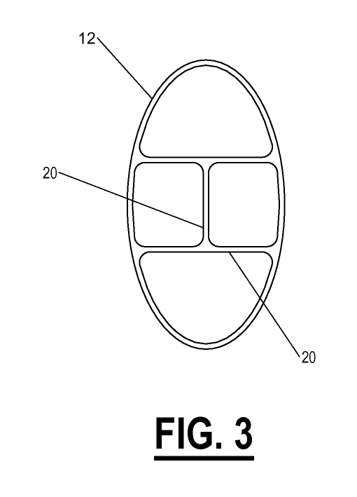

Referring now to FIGS. 2 and 3 as illustrative of an exemplary embodiment, a bicycle frame 10 according to the present invention provides a top tube 12 and a down tube 14, each made from extrusions having a webbed interior space, the webbing comprising partitions 20 (FIG. 3), described in more detail below. Each tube has two ends, one end of the top tube 12 and one end of the down tube 14 fixedly attached to a central portion of a head tube 16, and the other end of the top tube and the other end of the down tube fixedly attached to an upper end portion and a lower end portion of the seat tube 18, respectively. The top tube 12 is angled downwards from the head tube 16 so as to allow a rider to more easily mount and dismount the bicycle. Paired back stays 22 and paired chain stays 24, each stay having two ends, are each attached at one end to the seat tube 18 upper and lower ends, respectively, and at the other end, to each other, thus forming a pair of rear triangles.

FIG. 3 shows a cross section of the interior of one embodiment of the top tube 12. It should be noted that this cross section is also representative of an embodiment of the head tube 14. As shown in FIG. 3, the top tube 12 is provided as an oval or elliptical tube, hollow except for the webbed partitioning of the interior space. The oval or elliptical shape helps provide strength to the tube, and when oriented so that the minor axis of the elliptical shape is parallel to the ground when the bicycle is in an upright, riding position, also creates a more narrow (in respect to the horizontal) tube profile, allowing a rider to more easily mount and dismount the bicycle. More specifically, the top tube 12 is provided so as to have a webbed interior space having interior walls or partitions 20 running along its length, creating a plurality of open subspaces spanning at least some of the length of the webbed interior space of the tube. In a typical embodiment, the webbed interior space comprises at least three partitions 20 substantially spanning the length of the interior space, the partitions arranged so that two of the partitions are in spaced apart relation spanning the diameter and substantially spanning the length of the tube, and the third partition adjoins the other partitions, whereby four separately enclosed interior subspaces are provided within the webbed interior space. The interior webbing provides strength to the tube, without unduly weighing down the frame, and also provides internal channels or compartments, which allow mechanical and electrical components, such as cabling and electrical wiring, to be housed safely and in an organized manner, within the tube.

Referring now again to FIG. 2, holes 12a 14a in the tubes 12 14 permit the entry and exit of the components in and out of the tubes 12 14, resulting in a sleek look to the frame, and preventing possible damage to the cables and other components from weathering and physical damage from the rider mounting or dismounting the bicycle, or from rough handling, such as when the bicycle is thrown on the ground. The interior webbed design keeps the cables and other components from tangling, thus aiding installation and future replacement.

Each tube 12 14 and the partitions 20 forming its interior webbing are typically manufactured as a single piece of extruded aluminum or alloy thereof, but may instead be made of extrusions of other high strength, lightweight metallic materials, such as tungsten and/or tungsten alloys. The extrusion method of manufacturing the tubes is typically used because it allows the webbed interior and the exterior tube to be made as a single piece.

It is to be understood that the above-described arrangements are only illustrative of the application of the principles of the present invention. Numerous modifications and alternative arrangements may be devised by those skilled in the art without departing from the scope of the present invention.

What is claimed is:

1. A frame for a bicycle, the frame comprising:
a top tube;
a down tube;
a head tube; and
a seat tube;
wherein one end of the top tube and one end of the down tube are fixedly attached to a central portion of the head tube; and
wherein the other end of the top tube and the other end of the down tube are fixedly attached to an upper end portion and a lower end portion of the seat tube, respectively; and
wherein at least either the top tube or the down tube is provided as a tube having a respective webbed interior space, each such webbed interior space having interior walls running along its length and so having two or more open subspaces spanning at least some of the length of the tube having the webbed interior space.

2. A bicycle frame as in claim 1, wherein at least one of the webbed interior spaces comprises at least three partitions substantially spanning the length of the interior space, the partitions arranged so that two of the partitions are in spaced apart relation spanning the diameter and substantially spanning the length of the tube having the webbed interior space, and the third partition adjoins the other partitions, whereby four separate partitions are provided within the webbed interior space, for housing electrical and mechanical cable components and for providing increased strength of the bicycle frame.

3. A bicycle frame as in claim 1, wherein the top tube is substantially oval-shaped and attached so as to be more narrow in top profile than in side profile.

4. A bicycle frame as in claim 1, wherein the top tube is attached so as to angle downward from the head tube to the seat tube, whereby a rider can more easily mount or dismount the bicycle.

5. A bicycle frame as in claim 1, wherein the tubes having a respective webbed interior space are each made from one or more extrusions of a high strength lightweight metallic material.

6. A bicycle frame as in claim 1, wherein the tubes having a respective webbed interior space are each made from one or more extrusions of aluminum or an aluminum alloy.

7. A bicycle frame as in claim 1, wherein the tubes having a respective webbed interior space are each made from one or more extrusions of tungsten or a tungsten alloy.
